(19) United States
(12) Patent Application Publication
(10) Pub. No.: US 2012/0132152 A1
(43) Pub. Date: May 31, 2012

(54) Small animal support/restraint device

(76) Inventors: Sylvia Glee Thacker, Selmer, TN (US); Paul Eathel Thacker, Selmer, TN (US); James Elliott Thacker, Selmer, TN (US)

(21) Appl. No.: 12/927,834

(22) Filed: Nov. 26, 2010

(51) Int. Cl. A01K 15/04

(52) U.S. Cl. 119/749

(57) ABSTRACT

Small animal support/restraint device with a mount attached to building structure to station the device over the work surface, eliminating interference with accessing the animal and providing reliable stability. Descending from the mount, a height adjustable vertical post with pivot positioned at the lower end facilitates a rotating crossbar to which sliding eyes are attached for connecting loops and belts for tethering the animal.

### BACKGROUND OF THE INVENTION

This invention relates to a device that can assist those in the veterinary and grooming professions with control and support, as needed, when examining and treating or grooming pets. The invention can accommodate a variety of small four-footed animals, but its use is particularly valuable in the control of domestic dogs.

There is an inexhaustible list of reasons why pets delivered to veterinarians or groomers for services are unwilling or unable to cooperate. Veterinarians generally rely upon an assistant to control the animal or sedate it if it is uncooperative. Groomers typically use apparatus fastened to their table to which they attach commonly used loops or belts to tether the dog.

Controlling a resisting dog exposes personnel to physical harm and is exhausting. Sedation is often objectionable to owners; nor does the pet learn how to cooperate, so there is never any improvement in the dog's behavior in subsequent visits. Prior art has sought to remedy these problems with limited success.

Grooming arms attached to the table cannot prevent a dog from leaping or falling off the table, subsequently hanging itself, and have only minimal success at restraint. Devices that utilize a post or posts mounted at each end of the grooming table and connected by an overhead bar diminish accessibility to the animal. The dog can still overturn the table if it fights restraint; additionally there have been many cases of the table snapping because of the pressure exerted on the table.

Even if the dog behaves reasonably well, equipment attached to the table is an interference to working on the animal. Additionally, to change its position, the animal must be disconnected, picked up, repositioned, and reconnected repeatedly during the grooming process often causing it to scramble.

This device is not attached to the working surface. It has an overhead mount that positions the device above the center of the work surface or table. Descending downward from the mount is a height-adjustable telescoping vertical tube that receives a pivoting cross beam furnished with free positioning eyelets for attaching neck loops and belts.

This invention enables the operator to position the dog in its natural standing posture and keep it centered on the table using commonly available loops and belts. There is no need to pick up the animal as it can be rotated 360 degrees with minimal effort from the operator and locked in place every 45 degrees; and there is no interference to reaching any part of the dog's anatomy in the entire circumference of the animal.

The animal quickly accepts his restraint as adjustments for height and length of the pet can be tailored to each individual, comfortably accommodating any size dog. Because the device provides comfortable, safe restraint and in no way diminishes the dignity of the pet, yet cannot be evaded, the pet quickly learns to cooperate. Each successive session produces a more willing and cooperative pet.

### SUMMARY OF THE INVENTION

Briefly described to a preferred embodiment, the present invention consists of an animal restraint/support device enabled to be suspended above a work area or table by means of a mount, positioned on the ceiling or wall structural members. Both mounts receive the same assembly of components that complete the device. The device has a vertical stanchion with telescoping tube that facilitates height adjustment by means of aligning holes and securing the position with a locking pin. A pivot provides the means to attach a crossbar with the ability to rotate and lock as needed. Slides with means for attaching loops or belts can be moved along the crossbar to preferred positions and tightened in place.

It is the object of the present invention to provide a support/restraint device that is independent of the table thus eliminating the interference with apparatus attached to the work surface or table.

It is another object of the present invention to provide stability attained by attachment of the device to the building structural members, overcoming problems related to apparatus attached to the work surface or table occasionally being responsible for the overturning of a table when an animal exhibits strenuous resistance.

It is another object of the present invention to provide a rotation device that enables the animal to be rotated 360 degrees using minimal effort without the operator leaving his/her position.

It is another object of the present invention to provide a device that can accommodate any size dog with simple adjustments to the vertical post and slides as well as selection of the appropriate length crossbar.

It is another object of the present invention to provide a device that can safely and comfortably restrain or support an animal as needed while allowing the animal to lie, sit, or stand as required.

It is another object of the present invention to provide an aesthetically attractive, durable product suitable for commercial use.

### BRIEF DESCRIPTION OF THE DRAWINGS

The superior features of the present invention will become obvious with reference to the following more comprehensive description taken in conjunction with the several figures of the drawing in which:

FIG. 1 is a perspective view of the preferred embodiment of animal support/restraint device equipped with ceiling mount;

FIG. 2 is a view of the ceiling mount assembly;

FIG. 3 is a view of the stanchion assembly;

FIG. 4 is a view of the detent pivot block assembly;

FIG. 5 is a view of the rotating cross bar assembly;

FIG. 6 is a view of the wall mount adapter.

### DETAILED DESCRIPTION

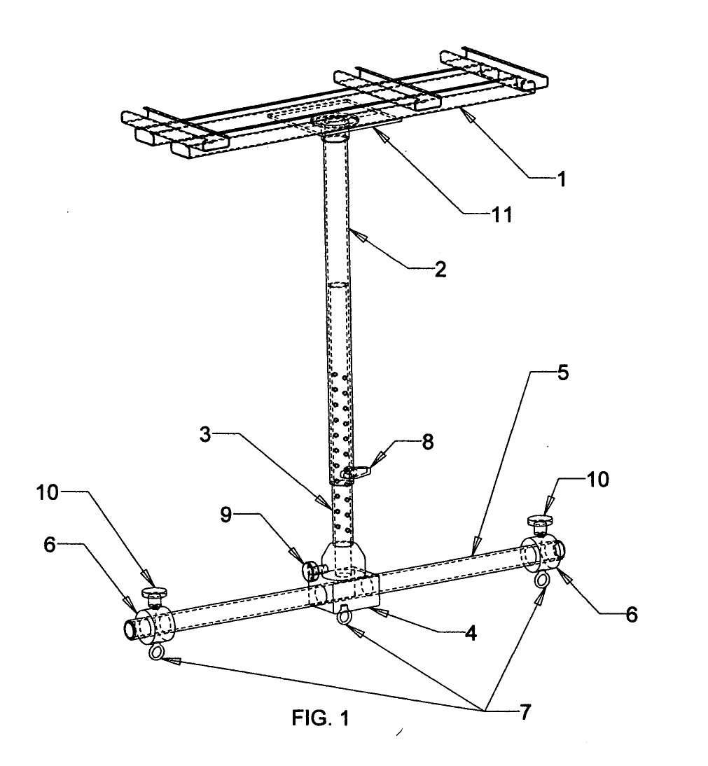

Referring to FIG. 1 illustrates the preferred embodiment of the ceiling mounted animal support/restraint device.

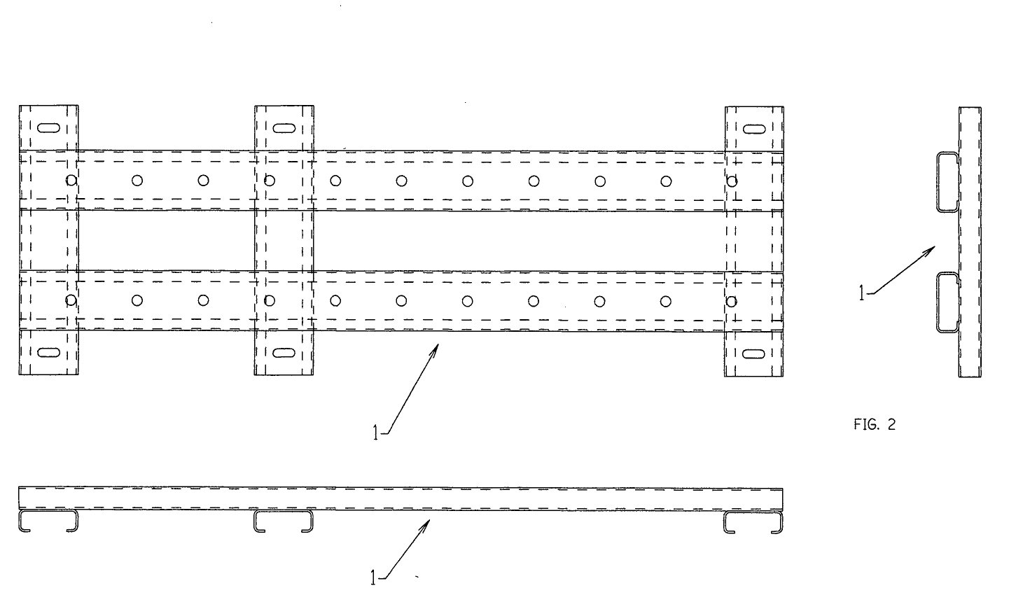

The ceiling mount assembly illustrated FIG. 2 is an assembly of two formed bars having identical hole patterns positioned parallel to each other, fastened with three formed bars of shorter width placed at a right angle across and extending beyond the outside edges of the first two and welded. These transverse bars are positioned to select 16 or 24 inch joist centers, with holes to accept mounting hardware. The hole pattern in the parallel bars allows for nine different mount positions of the stanchion base plate to enable the device to be centered above the work surface.

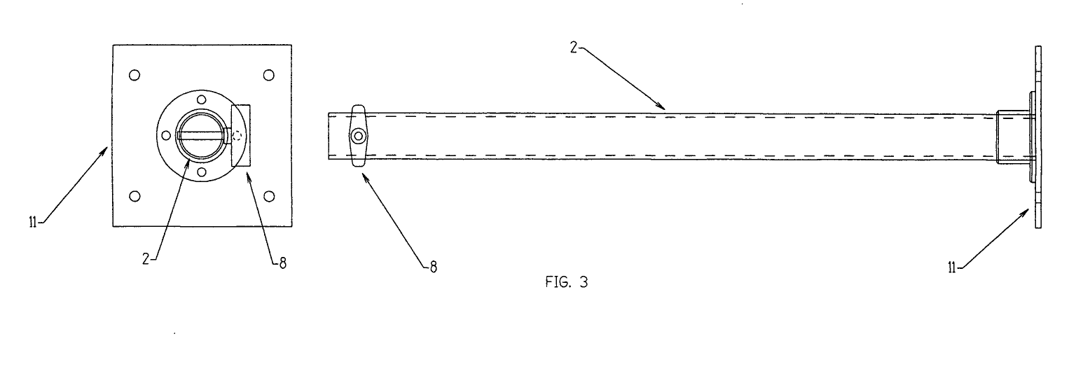

The stanchion assembly FIG. 3 comprises the machined base plate with flange 11 for holding the tubular stanchion 2 and the inner telescoping tube 3, both with aligning holes to select for variable height and a locking pin 8 to secure the position. The variable height position enables the operator to position any size dog on the work surface in a standing posture or let the animal assume a sitting or lying position by raising or lowering the telescope tube 3, aligning the holes, and inserting the lock pin 8.

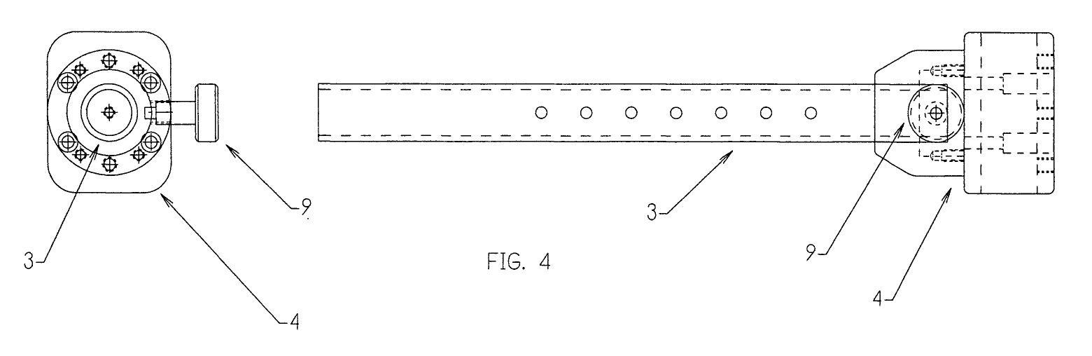

The detent pivot block assembly FIG. 4 is comprised of a full machined pivot block 4 that is fastened to the welded telescope tube 3 and a pivot lock knob 9. When the pivot lock knob 9 is pulled out, it releases the pivot block 4 to rotate on the telescope tube 3 allowing for 360 degree rotation. If released, the pivot lock knob 9 will snap back into the next locking position allowing for eight detent adjustments at 45 degree intervals. If the pivot lock 9 is pulled and rotated 90 degrees it will not snap back into the next detent position, allowing free 360 degree rotation.

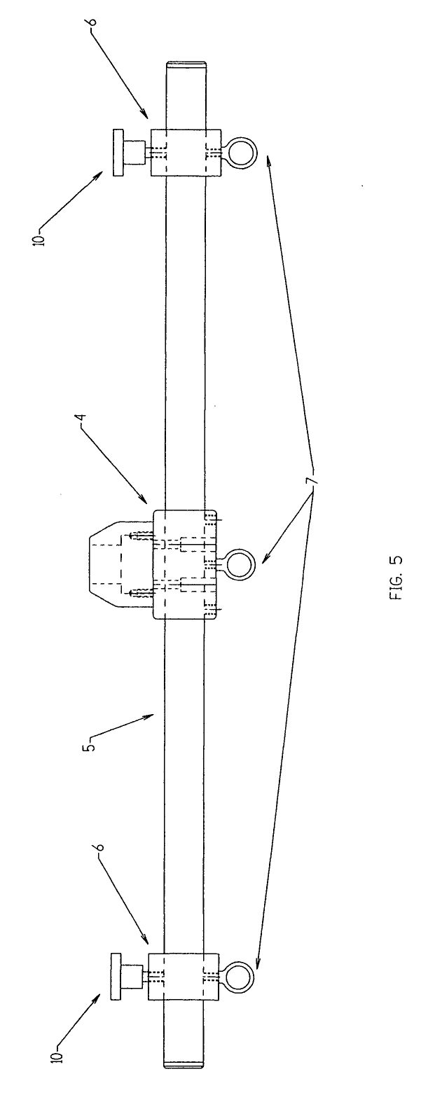

The interchangeable cross bar 5 shown FIG. 5 is held in position in the pivot block 4 by two inset screws on the base which are tightened against the bar to retain or loosened to remove. A shorter bar is preferred for working with smaller animals, but a longer bar is required to provide the axis to easily turn a larger animal effortlessly and individualize specific attachment needs, comfortably accommodating the animal.

The machined adjusting slides 6 can be moved freely on the cross bar 5 to a desired position, providing placement of loops or belts about the neck and rear quarters as needed and locked with the adjusting slide lock knobs 10. Eyelets 7 for attachment of loops or belts are fastened to the bottom of the adjusting slides 6 and the detent pivot block 4. The stationary eyelet in the center of the pivot base is all that is necessary for attachment of nooses or belts when strict control is not essential. Being centered on the work surface makes an animal feel more secure. The center eyelet provides additional means of support for disabled pets.

Other mechanical means, such as jam cleats, can be fitted to the slides 6 and used as an alternate to or in conjunction with eyelets 7.

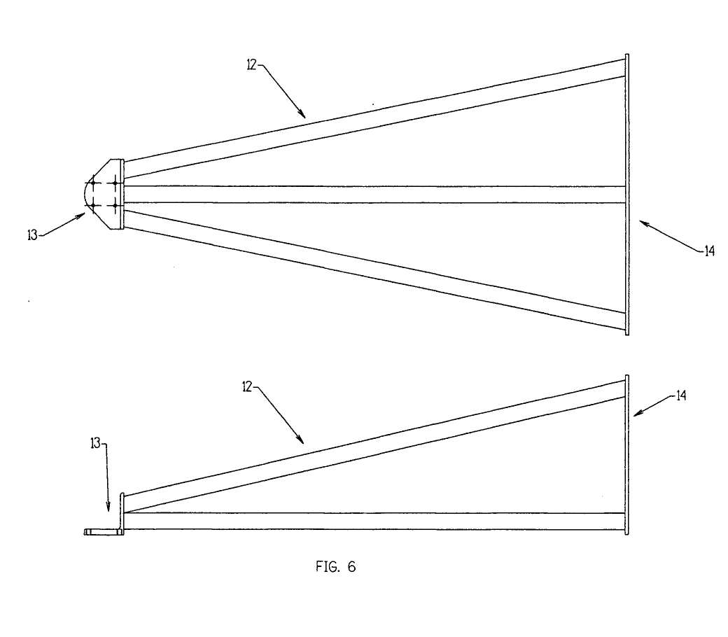

The wall mount adapter FIG. 6 will be the choice for structures where installation of the ceiling mount version is not feasible. It consists of a machined wall mount 12 made of welded tubes, constructed as an equitable triangle to distribute the burden of weight against the wall mount base plate 14, and the wall mount bolt plate 13 that mates to the stanchion assembly.

The distance from the wall to the stanchion is adequate to allow comfortable space for maneuvering around the work surface and permitting rotation of any pet stationed in the device.

The materials used for construction are powder coated steel for the stationary parts and anodized aluminum for the movable parts, making it durable and easy to use. Other materials, such as commercial plastics, are possible when strong enough to safely fulfill the purpose of the device.

### LIST OF REFERENCE NUMBERS

1. Ceil Mount
2. Tubular Stanchion
3. Telescope Tube
4. Detent Pivot Block
5. Interchangeable Cross Bar
6. Adjusting slide
7. Eyelets
8. Height Locking Pin
9. Pivot Lock Knob
10. Adjusting Slide Lock Knob′
11. Stanchion Base Plate
12. Wall Mount
13. Wall Mount Bolt Plate
14. Wall Mount Base Plate

References

| | | |
|---|---|---|
| 3208432 | September 1965 | Fisk |
| 3250252 | May 1966 | Leopold |
| 3524434 | August 1970 | Finley |
| 3744457 | July 1973 | Heine et al. |
| 4003341 | January 1977 | La Croix |
| 4570577 | February 1986 | Bellinger |
| 5488926 | February 1996 | Hunt |
| 5943983 | August 1999 | Drew et al. |
| 5960746 | October 1999 | Salts |
| 6516753 | February 2003 | Taylor |
| 7806089 | Oct. 5, 2010 | Walker-Indyke et al. |

The invention claimed is:

1. A small animal support/restraint device which comprises: an option of two mounts, ceiling or wall, permitting the device to be centered over and independent from the work surface; including a stanchion assembly containing a height adjustable telescoping tube, at the lower portion of which is a pivoting block facilitating 360 degree rotation of the interchangeable, various length crossbars equipped with laterally adjusting slides for positioning eyes or jam cleats to connect animal restraints.

2. The small animal support/restraint device of claim 1 wherein said optional ceiling mount can be attached at 16 or 24 inch placements according to building structure; additionally enabled with multiple hole patterns to select various mount positions for fastening the stanchion assembly to permit the most advantageous location over the work surface.

3. The small animal support/restraint device of claim 1 wherein said optional wall mount consisting of a wall mount plate, wall mount bolt plate, and welded tubes forming an equitable triangle, is mounted to wall framing members with lag screws.

4. The small animal support/restraint device of claim 1 wherein said stanchion assembly consists of a base plate fastened to the overhead mount and the stanchion tube which accepts the telescoping tube each with holes to align for selected vertical height adjustment and secured with locking pin.

5. The small animal support/restraint device of claim 1 wherein a pivoting block is positioned at the lower portion of said tube to facilitate free 360 degree rotation of the crossbar about the axis of the telescope tube while retaining height setting and provide indexed locking detents every 45 degrees to prevent further rotation of cross tube once engaged.

6. The small animal support/restraint device of claim 1 wherein interchangeable cross bar slides into the detent block and locks into place.

7. The small animal support/restraint device of claim 1 wherein the adjusting slides, equipped with eyelets or jam cleats, slide freely on the cross bar to a desired position and lock with the adjusting slide lock knobs.
